(19) United States
(12) Patent Application Publication
(10) Pub. No.: US 2025/0252302 A1
(43) Pub. Date: Aug. 7, 2025

(54) DISTRIBUTED SENSOR DATA COLLECTION FOR OPTIMIZED, CENTRALIZED TRAINING OF MACHINE LEARNING MODELS

(71) Applicant: EATON INTELLIGENT POWER LIMITED, Dublin 4 (IE)

(72) Inventors: Padhraig RYAN, Keatingstown (IE); Eugene RYAN, Glasnevin, Dublin (IE); James RYLE, Dublin 6 (IE)

(21) Appl. No.: 18/856,701

(22) PCT Filed: Apr. 14, 2022
(86) PCT No.: PCT/EP2022/025148

§ 371 Date: Oct. 14, 2024

(51) Int. Cl. G06N 3/08; G06N 3/0455

(52) U.S. Cl. CPC G06N 3/08; G06N 3/0455

(57) ABSTRACT

Some embodiments relate to a method and system of optimizing sensor data collection for centralized training of machine learning models. The method comprises identifying a data prioritization technique; collecting sensor data and implementing the identified data prioritization technique to prioritize the data for storage and transmission to a centralized repository; transmitting the data to the centralized repository; training the machine learning model on the centralized repository using the transmitted data to predict or identify events, such as failure in vehicles and other machinery; evaluating the data prioritization technique using a forward pass of an autoencoder to create an output; and determining an adjustment to the data prioritization technique based on the output.

### CROSS-REFERENCE TO RELATED APPLICATIONS

This application is a national phase filing under 35 C.F.R. § 371 of and claims priority to PCT Patent Application No. PCT/EP2022/025148, filed on Apr. 14, 2022, the contents of which are hereby incorporated in its entirety by reference.

### FIELD OF THE DISCLOSURE

The presently disclosed subject matter relates to a method and system of optimizing sensor data collection for centralized training of machine learning models

### BACKGROUND OF THE DISCLOSURE

Machine learning models can be trained to predict or identify events such as failure in vehicles and other machinery. The learning process is typically data-intensive. This typically requires data collection from a large number of machines and operational states (e.g. different failure modes).

One approach is to transmit (e.g. via Bluetooth or WiFi) sensor data from the edge device (e.g. from a sensor module on a machine) for training on the cloud. The data may be compressed using established techniques, for more efficient power and bandwidth consumption. However, signals such as Bluetooth or WiFi require a significant current and impact battery life. Additionally, network connectivity constraints may limit the amount of data that can be transferred.

An alternative approach is known as federated learning. This allows training to occur on local “edge” devices without transmitting training data to the cloud. However, this requires significant bandwidth to repeatedly transmit intermediate values of neural network weight layers between devices during training, and this too significantly reduces battery life. This negative impact on battery life limits the adoption of federated learning in real-world applications. Also, in applications where local data distributions differ substantially among agents, federated learning can perform poorly in comparison with centralized training. For example, Ozdayi et al., “Improving Accuracy of Federated Learning in Non-IID Settings”, Cornell University, 2020 describes a 10-17% drop in accuracy in some applications. Therefore, transmitting data to a central repository such as cloud storage for model training, offers advantages in terms of model accuracy.

This disclosure adopts a centralized model training in order to exploit the accuracy of the resulting models (compared to a federated learning approach), with optimizations to improve data selection and battery life.

### SUMMARY OF THE DISCLOSURE

In accordance with a first aspect of the presently disclosed subject matter, there is provided a method of optimizing sensor data collection for centralized training of machine learning models, comprising: identifying a data prioritization technique; collecting sensor data and implementing the identified data prioritization technique to prioritize the data for storage and transmission to a centralized repository; transmitting the data to the centralized repository; training the machine learning model on the centralized repository using the transmitted data to predict or identify events, such as failure in vehicles and other machinery; evaluating the data prioritization technique using a forward pass of an autoencoder to create an output; and determining an adjustment to the data prioritization technique based on the output.

Preferably, the identifying the data prioritization technique comprises: assembling a sample dataset from the sensor data; characterising the dataset by identifying characteristics of the dataset and the sample frequency; characterising the system constraints to determine the percentage of data to be stored, transmitted and discarded, wherein the system constraints comprise at least one of an available memory, a remaining battery level and an identified network connectivity; identifying potential data prioritization techniques using the characterised dataset and the characterised system constraints; and identifying an optimal prioritization technique.

Preferably, implementing the identified data prioritization technique to prioritize the data for storage and transmission to a centralized repository, comprises: evaluating the similarity, using distance metrics, of the sensor data which is collected at different time periods to determine the sensor data which is to be prioritized for storage and transmission; and based on the evaluation, the sensor data which is determined to represent an under-represented operational state is prioritized for storage and transmission; wherein the under-represented operational state is sensor data whose incidence in the model training data falls below a threshold relative to the detected frequency of other operational states, wherein the threshold is one of a fixed threshold, an adaptive threshold, or an order-based threshold.

Preferably, the evaluating the similarity, using distance metrics, of the sensor data which is collected at different time periods, comprises: training the autoencoder to encode and reproduce the sensor data; and measuring the result using a metric.

Preferably, the distance metric comprises:

$$Cosine Distance = \frac{{\sum }_{i = 1}^{n} ( {A}_{i} {B}_{i} )}{\sqrt{( {\sum }_{i = 1}^{n} {A}_{i}^{2} )} \sqrt{( {\sum }_{i = 1}^{n} {B}_{i}^{2} )}} ,$$

wherein A is an input vector, Aᵢ is an element of the vector A, B is an output vector, Bᵢ is an element if the output vector, and n is a rank of the vectors A and B.

Preferably, training the machine learning model on the centralized repository using the transmitted data comprises: checking the accuracy of the machine learning model against a predefined benchmark.

Preferably, the evaluating the data prioritization technique using a forward pass of an autoencoder comprises: performing a single forward pass of the autoencoder for each sample of the collected sensor data, wherein the single forward pass comprises: multiplying the sensor data input by a weight matrix specified in the first layer of the model; applying a transformation to the multiplied sensor data; applying operations specified in subsequent layers of the autoencoder to an intermediate autoencoder layer output, to create an output; measuring a distance between the input and the output; and if the distance exceeds a threshold, then adjusting the prioritization technique by retraining the prioritization technique, and if the distance does not exceed the threshold then maintaining the prioritization technique.

In accordance with a second aspect of the presently disclosed subject matter, there is provided a system of one or more sensors and a centralized repository for optimizing sensor data collection for centralized training of machine learning models, the system configured to: identify, using the one or more sensors, a data prioritization technique; collect, using the one or more sensors, sensor data and implement the identified data prioritization technique to prioritize the data to store, using a local memory on the one or more sensors, and transmit to the centralized repository; transmit the data to the centralized repository if network connectivity is available; train the machine learning model on the data in the centralized repository; evaluate the data prioritization technique using a forward pass of an autoencoder to create an output; and determine an adjustment to the data prioritization technique based on the output.

Preferably, the identifying, using the one or more sensors, the data prioritization technique comprises: assembling, using the one or more sensors, a sample dataset from the sensor data; characterising, using the one or more sensors, the dataset by identifying characteristics of the dataset and the sample frequency; characterising, using the one or more sensors, the system constraints to determine the percentage of data to be stored, transmitted and discarded, wherein the system constraints comprise at least one of an available memory, a remaining battery level and an identified network connectivity; identifying, using the one or more sensors, potential data prioritization techniques using the characterised dataset and the characterised system constraints; and identifying, using the one or more sensors, an optimal prioritization technique.

Preferably, implementing, using the one or more sensors, the identified data prioritization technique to prioritize the data for storage and transmission to a centralized repository, comprises: evaluating the similarity, using distance metrics, of the sensor data which is collected at different time periods to determine the sensor data which is to be prioritized for storage and transmission; and based on the evaluation, the sensor data which is determined to represent an under-represented operational state is prioritized for storage and transmission; wherein the under-represented operational state is sensor data whose incidence in the model training data falls below a threshold relative to the detected frequency of other operational states, wherein the threshold is one of a fixed threshold, an adaptive threshold, or an order-based threshold.

Preferably, the evaluating the similarity, using distance metrics, of the sensor data which is collected at different time periods, comprises: training the autoencoder to encode and reproduce the sensor data; and measuring the result using a metric.

Preferably, the metric comprises:

$$Cosine Distance = \frac{{\sum }_{i = 1}^{n} ( {A}_{i} {B}_{i} )}{\sqrt{( {\sum }_{i = 1}^{n} {A}_{i}^{2} )} \sqrt{( {\sum }_{i = 1}^{n} {B}_{i}^{2} )}} ,$$

wherein A is an input vector, Aᵢ is an element of the vector A, B is an output vector, Bᵢ is an element if the output vector, and n is a rank of the vectors A and B.

Preferably, training the machine learning model on the data in the centralized repository using the transmitted data comprises: checking the accuracy of the machine learning model against a predefined benchmark.

Preferably, the evaluating the data prioritization technique using a forward pass of an autoencoder comprises: performing a single forward pass of the autoencoder for each sample of the collected sensor data, wherein the single forward pass comprises: multiplying the sensor data input by a weight matrix specified in the first layer of the model; applying a transformation to the multiplied sensor data; applying operations specified in subsequent layers of the autoencoder to an intermediate autoencoder layer output, to create an output; measuring a distance between the input and the output; and if the distance exceeds a threshold, then adjusting the prioritization technique by retraining the prioritization technique, and if the distance does not exceed the threshold then maintain the prioritization technique.

### DETAILED DESCRIPTION OF DRAWINGS

Embodiments of the presently disclosed subject matter will now be described by way of example only and with reference to the accompanying drawings, in which:

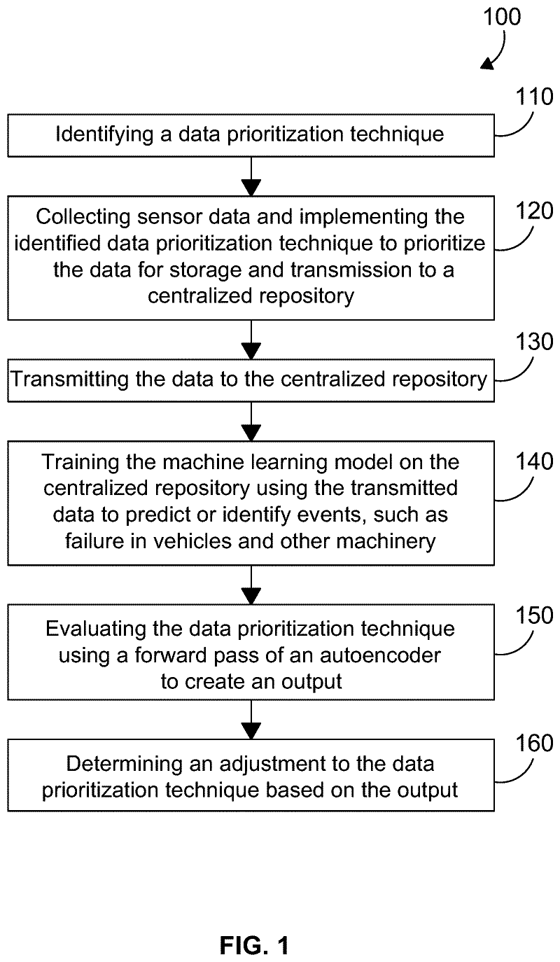

FIG. 1 depicts a method in accordance with the first aspect of the presently disclosed subject matter;

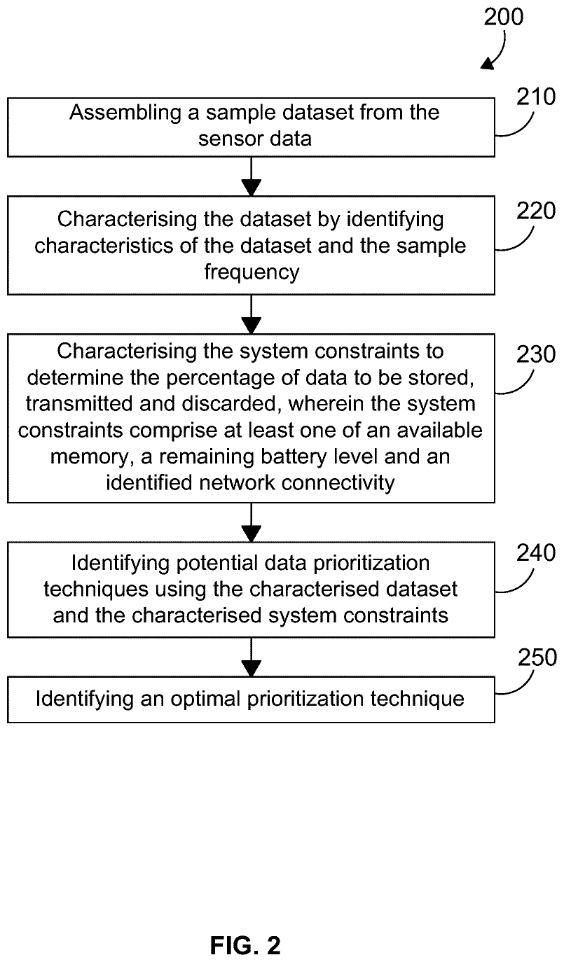

FIG. 2 depicts a preferred method of identifying a data prioritization technique;

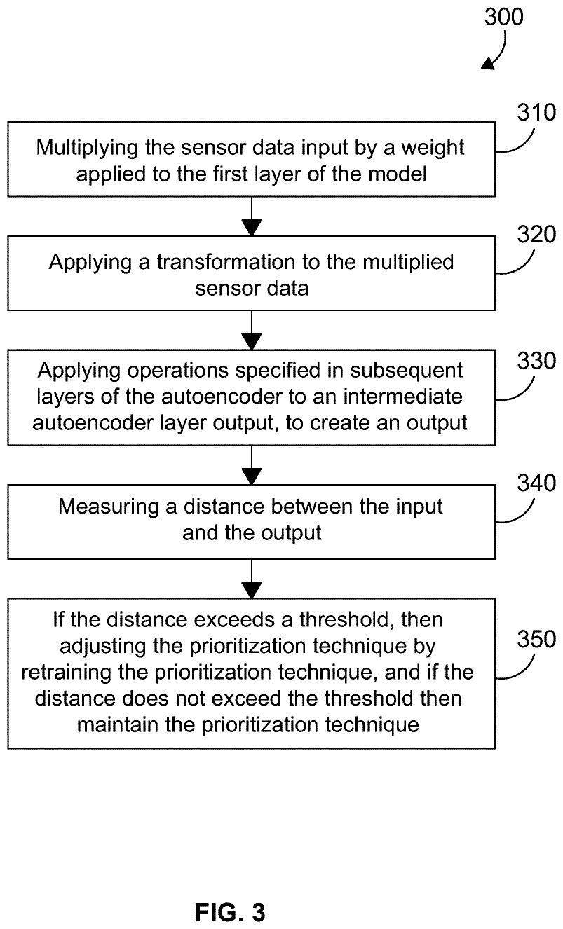

FIG. 3 depicts a preferred method of evaluating the data prioritization technique using a forward pass of an autoencoder;

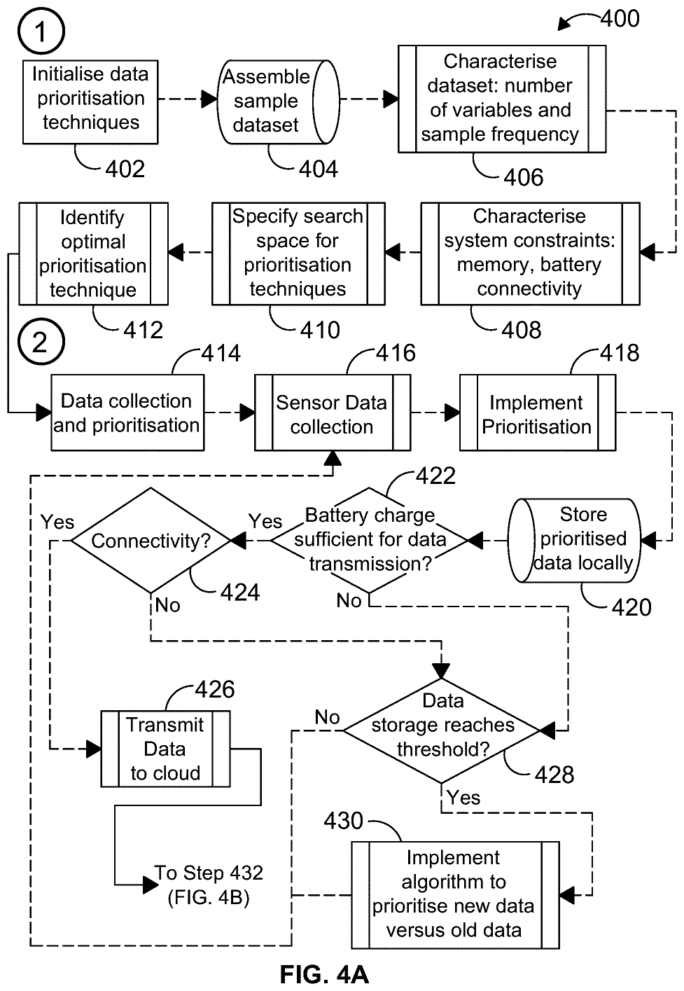

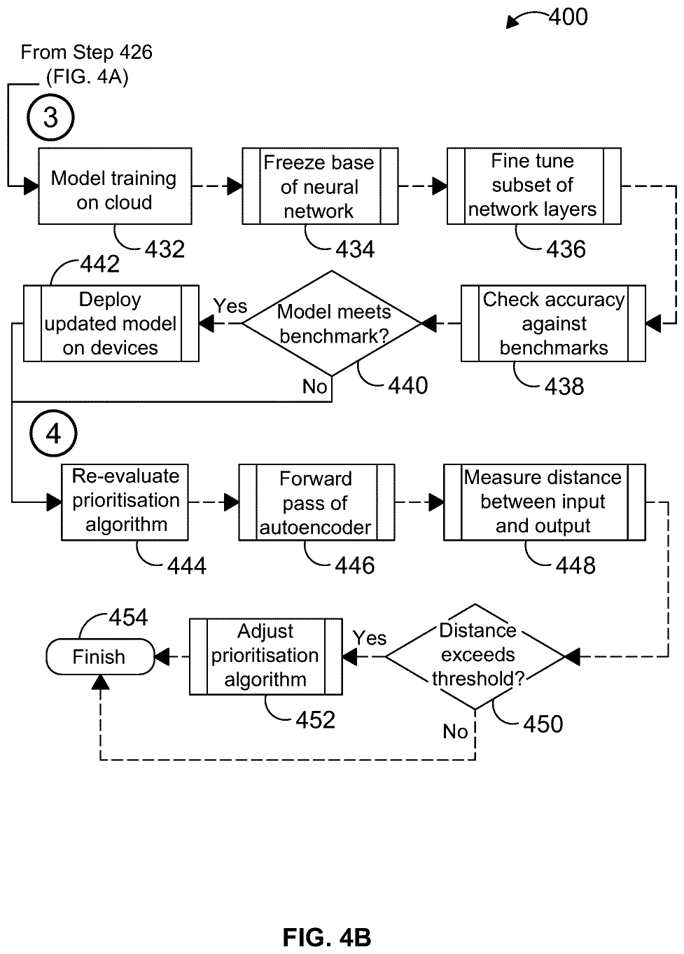

FIGS. 4A and 4B depict a flow-diagram of a method of the presently disclosed subject matter; and

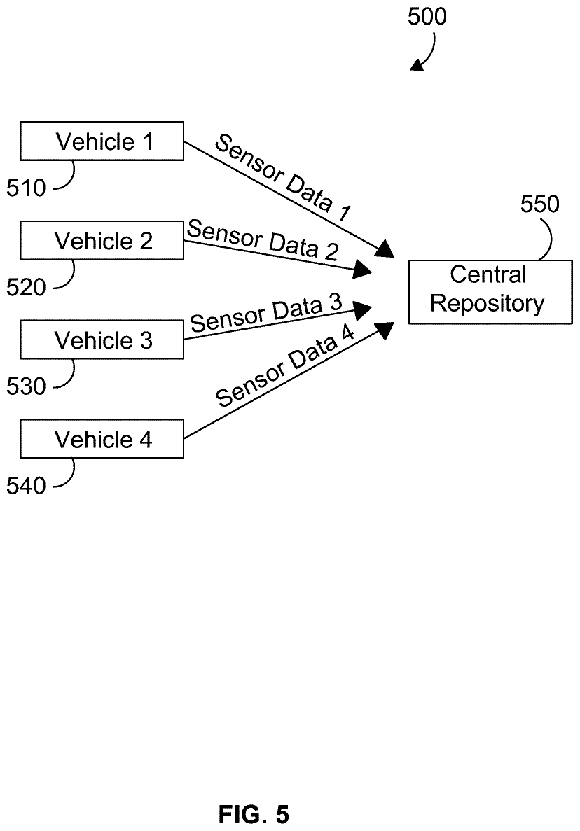

FIG. 5 depicts an exemplary embodiment of the presently disclosed subject matter.

With reference to FIG. 1, this depicts a method 100 in accordance with the first aspect of the presently disclosed subject matter. The method 100 of FIG. 1 comprises steps 110 to 160. Step 110 comprises identifying a data prioritization technique. Step 120 comprises collecting sensor data and implementing the identified data prioritization technique to prioritize the data for storage and transmission to a centralized repository (e.g. the cloud). Step 130 comprises transmitting the data to the centralized repository. Step 140 comprises training the machine learning model on the centralized repository using the transmitted data to predict or identify events, such as failure in vehicles and other machinery. Step 150 comprises evaluating the data prioritization technique using a forward pass of an autoencoder to create an output; and step 160 comprises determining an adjustment to the data prioritization technique based on the output.

With reference to FIG. 2, this depicts a method 200 of identifying the data prioritization technique. The method 200 of FIG. 2 comprises steps 210 to 250. Step 210 comprises assembling a sample dataset from the sensor data. Step 220 comprises characterising the dataset by identifying characteristics of the dataset and the sample frequency. Step 230 comprises characterising the system constraints to determine the percentage of data to be stored, transmitted and discarded, wherein the system constraints comprise at least one of an available memory, a remaining battery level and an identified network connectivity. Step 240 comprises identifying potential data prioritization techniques using the characterised dataset and the characterised system constraints; and step 250 comprises identifying an optimal prioritization technique.

With reference to FIG. 3, this depicts a method 300 of a preferred method of evaluating the data prioritization technique using a forward pass of an autoencoder, wherein the autoencoder performs steps 310 to 350. Step 310 comprises multiplying the sensor data input by a weight matrix specified in the first layer of the model. Step 320 comprises applying a transformation to the multiplied sensor data. Step 330 comprises applying operations specified in subsequent layers of the autoencoder to an intermediate autoencoder layer output, to create an output. Step 340 comprises measuring a distance between the input and the output. Step 350 comprises determining if the distance exceeds a threshold, then adjusting the prioritization technique by retraining the prioritization technique, and if the distance does not exceed the threshold then maintaining the prioritization technique.

With reference to FIGS. 4A-4B, these depict a flow-diagram of a method 400 of the presently disclosed subject matter. The method comprises steps 402 to 454.

In steps 402 to 412 of FIG. 4A, a method of identifying a data prioritization technique is described. In step 402 data prioritisation techniques are initialised and in step 404 a sample dataset is assembled. Step 406 comprises characterising a dataset, including characterising a number of variables and sample frequency. Step 408 comprises characterising system constraints, wherein the system constraints that are characterised comprise memory, battery level and connectivity. In step 410, a search space is specified for the prioritisation techniques, and in step 412 an optimal prioritisation technique is identified.

In steps 414 to 426 of FIG. 4A, a method is described of collecting sensor data and implementing the identified data prioritization technique to prioritize the data for storage and transmission to a centralized repository. In step 414, a step of data collection and prioritisation is initialised. In step 416, sensor data is collected; in step 418 the prioritisation technique is implemented; and in step 420 prioritised data is stored locally. In step 422, it is determined whether a battery charge is sufficient for data transmission.

Where it is determined in step 422 that the battery charge is sufficient for data transmission, then the method proceeds to step 424. In step 424 it is determined whether there is suitable connectivity (e.g. suitable WiFi connectivity). If it is determined in step 424 that there is not suitable connectivity, then the method proceeds to step 428, described below. If it is determined that there is suitable connectivity, then the method proceeds to step 426, where in step 426 the data is transmitted to the cloud (i.e. a centralised repository) and the method proceeds to step 432.

Where it is determined in step 422 that the battery charge is not sufficient for data transmission, then the method proceeds to step 428. In step 428, it is determined if the data storage has reached a threshold. If it is determined in step 428 that the data storage has not reached the threshold, then the method returns to step 416 and sensor data is collected and the method continue from step 416. When it is determined in step 428 that the data storage has reached the threshold, then the method proceeds to 430, where in step 430 the prioritisation algorithm (i.e. the prioritisation technique) is implemented to prioritise new data, rather than old data, and the method returns to step 416. This process iteratively continues until it is determined in step 424 that there is suitable connectivity.

In steps 432 to 442 of FIG. 4B, a method is described of training the machine learning model on the centralized repository using the data transmitted in step 426, to predict or identify events (e.g. failure in vehicles and other machinery).

In step 432, a method of training a model on the cloud is initialised. In step 434, a base of the neural network is frozen. In step 436, the subset of network layers of the neural network are fine-tuned, and in step 438 the accuracy is checked against benchmarks. In an example, the fine-tuning of step 436 comprises making changes to the neural network to account for newly available data and further comprises changing the weights of later layers in the training process, while the weights of base layers remain unchanged in the training process. In step 440 it is determined whether the model meets the benchmark. If it is determined in step 440 that the model does not meet the benchmark then the method proceeds to step 444. If it is determined in step 440 that the model does meet the benchmark then the method proceeds to step 442. In step 442, the updated model is deployed onto the devices (i.e. the sensor devices which transmitted the data to the cloud in step 426).

In steps 444 to 454 of FIG. 4B, a method of evaluating the data prioritization technique and determining an adjustment to the data prioritization technique, is shown.

In step 444, a method of re-evaluating the data prioritisation technique is initialised. In step 446, a forward pass of an autoencoder implemented to create an output, and in step 448 a distance is measured between an input (i.e. sensor data) and the output. In step 450 it is determined if the measured distance of step 448 exceeds a threshold. If the distance does not exceed the threshold then the method proceeds to step 454 where the method finishes. If the distance does exceed the threshold then the method proceeds to step 452 where the prioritisation technique is adjusted. After the adjustment the method proceeds to step 454.

With reference to FIG. 5, this depicts an exemplary embodiment of a system 500 of the presently disclosed subject matter. In the system 500, there is depicted a plurality of vehicles 510, 520, 530 and 540. Each of the plurality of vehicles 510, 520, 530 and 540 transmit sensor data (sensor data 1, 2, 3 and 4, respectively) to a central repository 550.

It will be appreciated that the above described embodiments of the first and second aspects of the presently disclosed subject matter are given by way of example only, and that various modifications may be made to the embodiments without departing from the scope of the presently disclosed subject matter as defined in the appended claims.

For example, in use step 110 of FIG. 1 may involve assembling a sample data set, as described in step 210 in relation to FIG. 2. The sample data set may be assembled in order to develop an initial characterisation of training data (i.e. sensor data). The training data may be from one or more devices including sensors. For example, during a predictive maintenance task (e.g. vehicle maintenance) a three-phase voltage and current may be collected for a selection of device and operation modes (e.g. high power mode, low power mode, failure mode).

Step 110 may further involve characterising the data set from the sensor data by analysing a number of variables and the sample frequency, as described in step 220 in relation to FIG. 2. For example, the characteristics analysed may include a data volume, data maximum, data minimum, data mean, data standard deviation and autocorrelation. Where a data set comprises multiple predictive variables, a correlation matrix may be used to characterise a relationship between the multiple predictive variables.

Step 110 may further comprise characterising system constraints, as described in relation to step 230 of FIG. 2. For example, the system constraints may comprise memory capacity, persistent storage, battery levels and connectivity capability. Characterising the system constraints may determine the percentage of sensor data to be stored, transmitted and discarded. For example, a system which has poor network connectivity and/or has low data storage capacity may be configured to discard a high volume of sensor data. According to the system constraints, data storage targets may be defined.

Step 110 may further comprise identifying a data prioritization technique by specifying a search space for prioritization techniques, as described in relation to step 240 of FIG. 2. Potential methods for data prioritization may be specified. For example, an autoencoder (described further below with respect to step 120) may be used for data prioritization. The number of layers of the autoencoder may be determined by the performance constraints (i.e. system constraints and the characteristics of the data sets described above) of the sensor devices (also called the local devices herein). By analysing the performance constraints, a search space of the prioritization techniques may be determined.

Step 110 may further comprise identifying an optimal prioritization technique by systematically exploring the search space, as described in relation to step 250 of FIG. 2. For example, this may involve training an autoencoder neural network to encode and reproduce input data. The optimal architecture of the autoencoder may be determined by the ability to minimize a distance between the input (i.e. input data) and an output (i.e. the output from the autoencoder). This is described further below with respect to step 120.

Step 120 of FIG. 1 may further comprise the collection and characterisation of sensor data on the local edge devices. For example, the sensors data may be collected from any device, such as a hydraulic pump, a diesel engine or any other device.

Step 120 may further comprise implementing the prioritization technique, determined in step 110 above. The prioritization technique may comprise an algorithm which evaluates the similarity, using distance metrics, of data collected at different time periods to determine which data is to be prioritized for data retention (i.e. storage). For example, data which has been determined to be more distinct or which corresponds to a novel or under-represented operation state (e.g. a new fault mode) may be determined to be more valuable and may be prioritized for data transmission.

The distinctiveness of the data may be analysed using multiple methods. For example, an initial (first pass) prioritization test which may be utilised is to use summary statistics of a distribution of the sensor data. A second (or an alternative) prioritisation test may involve using an autoencoder (as described above in relation to step 110). An autoencoder is a type of artificial neural network which is trained to encode and then reproduce training data. The ability of the autoencoder to accurately reproduce the input data is a measure of data novelty which allows prioritization as described above. To assess the similarity between the autoencoder input and output, a metric such as a cosine distance may be calculated:

$$Cosine Distance = \frac{{\sum }_{i = 1}^{n} ( {A}_{i} {B}_{i} )}{\sqrt{( {\sum }_{i = 1}^{n} {A}_{i}^{2} )} \sqrt{( {\sum }_{i = 1}^{n} {B}_{i}^{2} )}} ,$$

wherein A is an input vector, Aᵢ is an element of the vector A, B is an output vector, Bᵢ is an element if the output vector, and n is a rank of the vectors A and B.

A larger value of the Cosine Distance equation, above, indicates that data is more distinct when compared to a lower value from the Cosine Distance equation, and is therefore more likely to improve the accuracy of a predictive model. In other words, a higher cosine distance provides a higher priority score for the data.

Step 120 may further comprise storing the prioritised data locally, based on available storage and the determined priority of new data. Furthermore, step 120 may involve determining if the battery charge is sufficient for data transmission. If the battery charge is sufficient, then it is determined if network connectivity is available to transmit the data. If network connectivity is available, then data can be transmitted to a central repository (e.g. the cloud) for model training. If network connectivity is unavailable (or insufficient) and/or if battery charge is insufficient for data transmission, then the method further comprises determining if the data storage has reached a specified threshold. If the threshold is met, then at least some data is discarded. New data may be prioritised for storage relative to old data.

In practice, Step 130 of FIG. 1 may further comprise compressing the data to be transmitted prior to transmission using a known method. For example, for a periodic signal, data can be converted from a time-domain to a frequency-domain using a fast Fourier transform (or some variant thereof). The frequency domain data may then be transmitted to the central repository where it can be used to recreate the underlying time-domain signal using algorithms, such as an inverse Fast Fourier Transform. This recreated signal may then be used as an input to the machine learning model training. A conventional approach to data augmentation is to use all of the available real data in the training dataset, and generate additional data by varying some values of data from their “true” value, within a predetermined probability distribution. For example, varying the scale, color, or rotation angle of images to offer additional input to a machine learning model. This can improve the generalizability of machine learning models to real-world settings.

Steps 150 and 160 of FIG. 1 may further comprise performing a single forward pass of the autoencoder, where the single forward pass is performed for each sample of recently collected data. Performing the single forward pass may involve multiplying the inputs by weights associated with the first layer of the model, applying a transformation (e.g. a rectified linear unit) and implementing each subsequent layer of the autoencoder network. The method may further comprise measuring a distance between the input and the output, and if it is determined that the distance exceeds a threshold, then adjusting the prioritization technique by retraining (i.e. fine tuning) using new data.

In relation to FIG. 4B, and in particular to step 432 which comprises freezing the base of the neural network, if the freezing of the base of the neural network may not be required if the predictive model has not yet been trained. In step 436, fine-tuning may further comprise training the neural network based on a user-defined search space, such as using hyper-parameters of the neural network which may be defined using a grid search. The model weights can be updated based upon a process of backpropagation and gradient descent. Alternatively, variants of gradient descent and backpropagation, such as by using an adaptive moment estimator or an root mean squared propagation. For example, the model weights may be updated using: θ¹=θ⁰−α∨̅ J(θ); Wherein α is the learning rate; θ¹ is the weight after the update; θ⁰ is the weight before the update; and ∨̅J(θ) is the weight differential.

1. A method of optimizing sensor data collection for centralized training of machine learning models, comprising:
identifying a data prioritization technique;
collecting sensor data and implementing the identified data prioritization technique to prioritize the data for storage and transmission to a centralized repository;
transmitting the data to the centralized repository;
training the machine learning model on the centralized repository using the transmitted data to predict or identify events, such as failure in vehicles and other machinery;
evaluating the data prioritization technique using a forward pass of an autoencoder to create an output; and
determining an adjustment to the data prioritization technique based on the output.

2. The method of claim 1, wherein the identifying the data prioritization technique comprises:
assembling a sample dataset from the sensor data;
characterising the dataset by identifying characteristics of the dataset and the sample frequency;
characterising the system constraints to determine the percentage of data to be stored, transmitted and discarded, wherein the system constraints comprise at least one of an available memory, a remaining battery level and an identified network connectivity;
identifying potential data prioritization techniques using the characterised dataset and the characterised system constraints; and
identifying an optimal prioritization technique.

3. The method of claim 1, wherein implementing the identified data prioritization technique to prioritize the data for storage and transmission to a centralized repository, comprises:
evaluating the similarity, using distance metrics, of the sensor data which is collected at different time periods to determine the sensor data which is to be prioritized for storage and transmission; and based on the evaluation, the sensor data which is determined to represent an under-represented operational state is prioritized for storage and transmission;
wherein the under-represented operational state is sensor data whose incidence in the model training data falls below a threshold relative to the detected frequency of other operational states, wherein the threshold is one of a fixed threshold, an adaptive threshold or an order-based threshold.

4. The method of claim 3, wherein the evaluating the similarity, using distance metrics, of the sensor data which is collected at different time periods, comprises:
training the autoencoder to encode and reproduce the sensor data; and measuring the result using a metric.

5. The method of claim 4, wherein the metric comprises:
$$Cosine Distance = \frac{{\sum }_{i = 1}^{n} ( {A}_{i} {B}_{i} )}{\sqrt{( {\sum }_{i = 1}^{n} {A}_{i}^{2} )} \sqrt{( {\sum }_{i = 1}^{n} {B}_{i}^{2} )}} ,$$
wherein A is an input vector, Aᵢ is an element of the vector A, B is an output vector, Bᵢ is an element if the output vector, and n is a rank of the vectors A and B.

6. The method of claim 1, wherein training the machine learning model on the centralized repository using the transmitted data comprises:
checking the accuracy of the machine learning model against a predefined benchmark.

7. The method of claim 1, wherein the evaluating the data prioritization technique using a forward pass of an autoencoder comprises:
performing a single forward pass of the autoencoder for each sample of the collected sensor data, wherein the single forward pass comprises:
multiplying the sensor data input by a weight matrix specified in the first layer of the model;
applying a transformation to the multiplied sensor data;
applying operations specified in subsequent layers of the autoencoder to an intermediate autoencoder layer output, to create an output;
measuring a distance between the input and the output; and
if the distance exceeds a threshold, then adjusting the prioritization technique by retraining the prioritization technique, and if the distance does not exceed the threshold then maintain the prioritization technique.

8. A system of one or more sensors and a centralized repository for optimizing sensor data collection for centralized training of machine learning models, the system configured to:
identify, using the one or more sensors, a data prioritization technique;
collect, using the one or more sensors, sensor data and implement the identified data prioritization technique to prioritize the data to store, using a local memory on the one or more sensors, and transmit to the centralized repository;
transmit the data to the centralized repository if network connectivity is available;
train the machine learning model on the data in the centralized repository;
evaluate the data prioritization technique using a forward pass of an autoencoder to create an output; and
determine an adjustment to the data prioritization technique based on the output.

9. The system of claim 8, wherein the identifying, using the one or more sensors, the data prioritization technique comprises:
assembling, using the one or more sensors, a sample dataset from the sensor data;
characterising, using the one or more sensors, the dataset by identifying characteristics of the dataset and the sample frequency;
characterising, using the one or more sensors, the system constraints to determine the percentage of data to be stored, transmitted and discarded, wherein the system constraints comprise at least one of an available memory, a remaining battery level and an identified network connectivity;
identifying, using the one or more sensors, potential data prioritization techniques using the characterised dataset and the characterised system constraints; and
identifying, using the one or more sensors, an optimal prioritization technique.

10. The system of claim 8, wherein implementing, using the one or more sensors, the identified data prioritization technique to prioritize the data for storage and transmission to a centralized repository, comprises:
evaluating the similarity, using distance metrics, of the sensor data which is collected at different time periods to determine the sensor data which is to be prioritized for storage and transmission; and based on the evaluation, the sensor data which is determined to represent an under-represented operational state is prioritized for storage and transmission;
wherein the under-represented operational state is sensor data whose incidence in the model training data falls below a threshold relative to the detected frequency of other operational states, wherein the threshold is one of a fixed threshold, an adaptive threshold, or an order-based threshold.

11. The system of claim 8, wherein the evaluating the similarity, using distance metrics, of the sensor data which is collected at different time periods, comprises:
training the autoencoder to encode and reproduce the sensor data; and measuring the result using a metric.

12. The system of claim 11, wherein the metric comprises:
$$Cosine Distance = \frac{{\sum }_{i = 1}^{n} ( {A}_{i} {B}_{i} )}{\sqrt{( {\sum }_{i = 1}^{n} {A}_{i}^{2} )} \sqrt{( {\sum }_{i = 1}^{n} {B}_{i}^{2} )}} ,$$
wherein A is an input vector, Aᵢ is an element of the vector A, B is an output vector, Bᵢ is an element if the output vector, and n is a rank of the vectors A and B.

13. The system of claim 8, wherein training the machine learning model on the data in the centralized repository using the transmitted data comprises:
checking the accuracy of the machine learning model against a predefined benchmark.

14. The system of claim 8, wherein the evaluating the data prioritization technique using a forward pass of an autoencoder comprises:
performing a single forward pass of the autoencoder for each sample of the collected sensor data, wherein the single forward pass comprises:
multiplying the sensor data input by a weight matrix specified in the first layer of the model;
applying a transformation to the multiplied sensor data;
applying operations specified in subsequent layers of the autoencoder to an intermediate autoencoder layer output, to create an output;
measuring a distance between the input and the output; and
if the distance exceeds a threshold, then adjusting the prioritization technique by retraining the prioritization technique, and if the distance does not exceed the threshold then maintain the prioritization technique.
